(19) United States
(12) Patent Application Publication
(10) Pub. No.: US 2009/0027800 A1
(43) Pub. Date: Jan. 29, 2009

(54) STORAGE APPARATUS, CONTROL METHOD AND CONTROL UNIT

(75) Inventors: Tohru IWAMOTO, Kawasaki (JP); Masahide KANEGAE, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/179,104

(22) Filed: Jul. 24, 2008

(30) Foreign Application Priority Data
Jul. 26, 2007 (JP) 2007-194571

(51) Int. Cl. G11B 21/02

(52) U.S. Cl. 360/75

(57) ABSTRACT

According to an aspect of an embodiment, a storage apparatus includes a judgment unit which judges the clearance between a head and a recording medium. A mode switcher switches from a regular write mode in which data is written on the medium to a write verification mode in which error is checked by reading the data immediately after writing on the medium, where the judgment unit detects a clearance change. A heater control value adjustor corrects for errors detected in the write verification mode by changing a prescribed heater control value for the heater by executing write verifications. An access processor controls the clearance between the head and the medium by heating the head according to the adjusted heater control value, to compensate for operational variables such as low atmospheric pressure.

### CROSS-REFERENCE TO RELATED APPLICATION

This application is based upon and claims the better of priority of the prior Japanese Patent Application No. 2007-194571, filed on Jul. 26, 2007, the entire contents of which are incorporated herein by reference.

### BACKGROUND

1. Field

An aspect of the invention is related to a storage apparatus, a control method and a control unit for reading and writing data by flying a head over a rotating recording medium. More particularly, an aspect of the invention is related to a storage apparatus, a control method and a control unit for controlling a clearance between the head and the recording medium by expanding the head with electric heat generated by a heater embedded in the head.

2. Description of Related Art

It has been required to reduce the clearance, in other words, a distance, between the reading and writing elements embedded in the head and a record surface of the magnetic disk to achieve higher recording density of magnetic disk devices. The magnetic disk devices have been designed so as to keep the flying height of the head constant by utilizing pressures, more specifically a positive pressure and a negative pressure produced by airflow between the slider having the head and the magnetic recording medium.

In order to increase a recording density, decreasing the distance between the head and the medium is needed. With the increasing recording density, the clearance between the head and the medium is getting decreased year after year. Today, the clearance between the head and the recording medium has decreased to on the order of several nanometers by expanding the head with electric heat generated by a heater embedded in the head.
[Patent document 1]
Japanese Laid-open Patent Publication No. 2006-107722
[Patent document 2]
Japanese Laid-open Patent Publication No. 07-262726.

Controlling the clearance between the head and the record surface of the magnetic disk by the heater embedded in the head does not pose any problem in a usual usage environment. However, if the magnetic disk device is installed in a low atmospheric pressure environment such as a highland, the clearance decreases, resulting in unwanted contact with the magnetic disk. Therefore, the data may not be written correctly. Consequently, the data is unable to be read correctly.

To avoid the problem arising in such low-atmospheric-environments, the clearance at a fabrication stage under ordinary atmospheric pressure (1 atmosphere) is adjusted to compensate for low atmospheric pressure by changing the settings of current applied to the heater. Yet, with this approach, the clearance is too high in the ordinary atmosphere in which the devices are usually used, resulting in a higher error rate.

Accordingly, an object of the disclosed technique is to provide a storage apparatus, a control method and a control unit for reading and writing data correctly without touching a recording medium with a head when the apparatus is designed to be capable of being used under low atmospheric pressure.

### SUMMARY

In keeping with one aspect of an embodiment of this technique, a storage apparatus includes a flying head having a heater for changing a clearance between the head and a rotating recording medium by expanding the head with an electric heat in accessing data written on the recording medium. The storage apparatus includes a judgment unit which judges the clearance between the head and the recording medium. A mode switcher switches from a regular write mode in which data is written on the recording medium to a write verification mode in which error is checked by reading the data immediately after writing on the recording medium when the judgment unit detects a clearance change. A heater control value adjustor corrects errors detected in the write verification mode by changing prescribed heater control values for the heater after executing write verifications. An access processor controls the clearance between the head and the medium by heating the head with the applied current according to the heater control value as adjusted, on receiving an access request issued from a higher level device.

Additional objects and advantages of the embodiment will be set forth in part in the description which follows, and in part will be obvious from the description, or may be learned by practice of the embodiment. The object and advantages of the embodiment will be realized and attained by means of the elements and combinations particularly pointed out in the appended claims.

It is to be understood that both the foregoing general description and the following detailed are exemplary and explanatory only and are not restrictive of the embodiment, as claimed.

### BRIEF DESCRIPTION OF THE DRAWINGS

The above and other objects, features, advantages and technical significance of this disclosed technique will be better understood by reading the following detailed description of presently preferred embodiment of the disclosed technique, when considered in connection with the accompanying drawings.

FIG. 1 is a block diagram showing a structure of a magnetic disk;

FIG. 2 is a block diagram showing a functional structure of a MPU;

FIG. 3 shows a parameter table;

FIG. 4 shows an inner structure of the magnetic disk device;

FIG. 5A shows a supporting structure of the head;

FIG. 5B shows a flying structure of the head;

FIG. 6A shows a flying head without applying current to the heater;

FIG. 6B shows the clearance between the medium and the head, controlled by expanding the head with the electric heat generated by the heater;

FIG. 7 shows a structure of the head in detail;

FIG. 8 is a block diagram of a heater control system;

FIG. 9 is a block diagram showing a circuit unit for detecting amplitude of a signal read with the head to estimate the clearance;

FIG. 10 shows a structure of a measurement track;

FIG. 11A is a graph showing a relationship between the clearance and the amplitudes of the signal read out with the head;

FIG. 11B is a graph showing a relationship between the clearance and servo gains;

FIG. 12 is a flow chart showing control processes executed by the magnetic disk device;

FIG. 13 is a flow chart showing write-clearance control processes; and

FIG. 14 is a flow chart showing read-clearance control processes.

### DESCRIPTION OF THE PREFERRED EMBODIMENTS

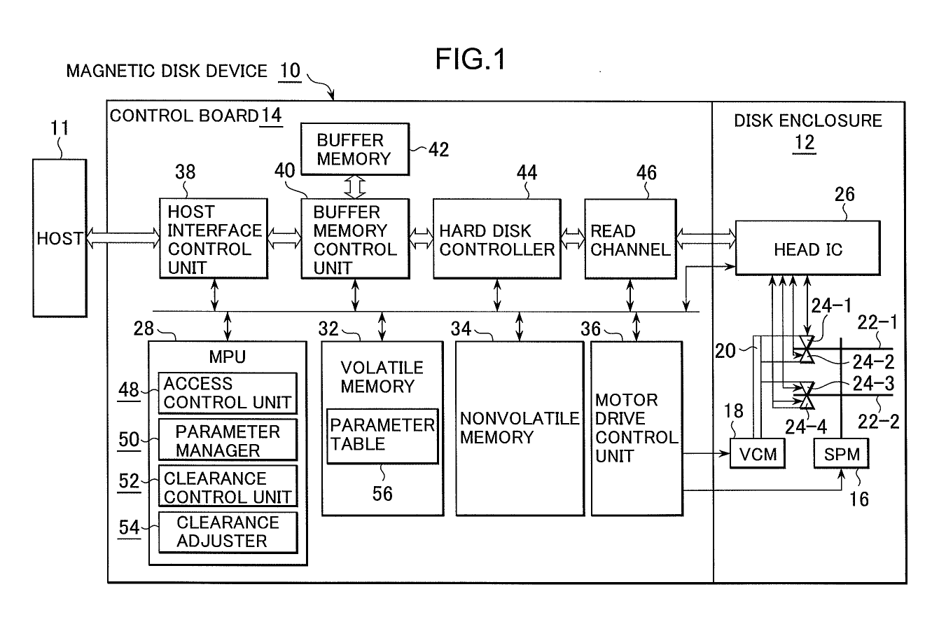

FIG. 1 is a block diagram showing a magnetic disk device as an embodiment of the storage apparatus according to this technique. In FIG. 1, magnetic disk device 10 known as a hard disk drive (HDD) has disk enclosure 12 and control board 14. Disk enclosure 12 has spindle motor 16. Magnetic disks 22-1 and 22-2 are mounted on a rotation axis of spindle motor 16 and rotated at a constant speed of 4200 rpm.

Disk enclosure 12 has voice coil motor 18. Voice coil motor 18 has rotary actuators 20 having heads 24-1 through 24-4 at their tips. Voice coil motor 18 drives rotary actuators 20 for positioning the heads above recording surfaces of magnetic disks 22-1 and 22-2.

Heads 24-1-24-4 are a combo head of a recording element and a reading element. As the write element of heads 24-1-24-4, a write element for the longitudinal magnetic recording or for the perpendicular magnetic recording will be available. For the write element for the perpendicular magnetic recording, a perpendicular recording medium having a recording layer and a soft magnetic under layer will be available as magnetic disks 22-1 and 22-2. As the read element, a giant magneto-resistance (GMR) element or a tunnel magneto-resistance (TMR) element is used.

Further, heads 24-1-24-4 according to this embodiment each have a heater embedded therein. The clearances between the heads and the recording surfaces of magnetic disk 22-1 and 22-2 are controlled by expanding the heads with electric heat generated by the heaters.

Heads 24-1-24-4 connect to head IC 26 with signal wires. Head IC 26 selects one of the heads by a head select signal according to a write command or a read command issued by host 11 that is a higher-level device and writes or reads data with the head. The head IC 26 has a write driver for writing and a preamplifier for reading.

Further, head IC 26 has a digital to analog (DA) converter for controlling the heater embedded in the head. The DA converter converts a heater control value sent from control board 14 into current to drive the heater and applies the current to the heater to control the clearance by thermally expanding the head with the current.

Control board 14 has micro processing unit (MPU) 28, volatile memory 32 for loading firmware containing a control program using a random access memory (RAM) and control data on bus 30 of MPU 28, and nonvolatile memory 34 storing parameters for the firmware using a flash ROM.

Motor drive control unit 36, host interface control unit 38, buffer memory control unit 40 for controlling buffer memory 42, hard disk controller 44, read channel 46 serving as a write modulator and a read modulator are on bus 30 of the MPU 28.

Those components of control board 14 such as MPU 28, volatile memory 32, nonvolatile memory 34, host interface control unit 38, buffer memory control unit 40, hard disk controller 44 and read channel 42 can be integrated on one LSI as a control unit.

Alternatively, an LSI may consist of hard disk controller 44 and read channel 46 other than the exemplary embodiment described above. In this case, the control unit may include a control circuit unit having a controller such as MPU 28.

Magnetic disk device 10 executes a write operation and a read operation by a command issued from host 11. Normal operations of magnetic disk device 10 are as follows.

First, a write command and write data sent from host 11 are received by host interface control unit 38. Second, MPU 28 decodes the write command and stores the write data received in buffer memory 42 as necessary. Third, hard disk control unit 44 converts the write data into a prescribed data format and adds ECC code thereto by the ECC encoding process. Then, the write modulator of the read channel 46 scrambles the data with the RLL code, and implements compensation for a write. Thereafter, the write data is written on the recording surface of magnetic disk 22-1 with the write element of a head selected by head IC 26 through the write amplifier, for example, the head 24-1.

On writing, MPU 28 sends a head positioning signal to motor drive control unit 36. With the head positioning signal, voice coil motor 18 drives the head to seek and position itself on a track specified by the command in a regular tracking control.

The regular reading processing is as follows. First, host interface control unit 38 receives a read command issued by host 11. Second, MPU 28 decodes the read command. Third, the preamplifier amplifies the signal read out with the read element of the head selected by head IC 26. Then the signal is fed into a demodulator of a read channel 46. Thereafter, the signal is demodulated by implementing automatic gain amplification, noise reduction with a low-pass filter, an A/D conversion, an automatic equalization with a FIR filter and the partial response maximum likelihood (PRML) method. After descrambling the signal by a RLL code reverse conversion, the signal is output to hard disk controller 44. Hard disk controller 44 checks and corrects errors of the signal by an ECC decoding processing. Buffer memory 42 stores the signal. Then host interface control unit 38 transfers the read data to host 11.

In addition, in writing or reading data when receiving the write command or the read command issued by host 11, a clearance from the head is controlled by the heater control value preset in an adjustment step at the fabrication stage to several nanometers of a target value.

MPU 28 of control board 14 has access processor 48, parameter manager 50, clearance control unit 52 and clearance adjustor 54 which perform functions implemented via the firmware including the control program. Volatile memory 32 is provided with parameter table 56.

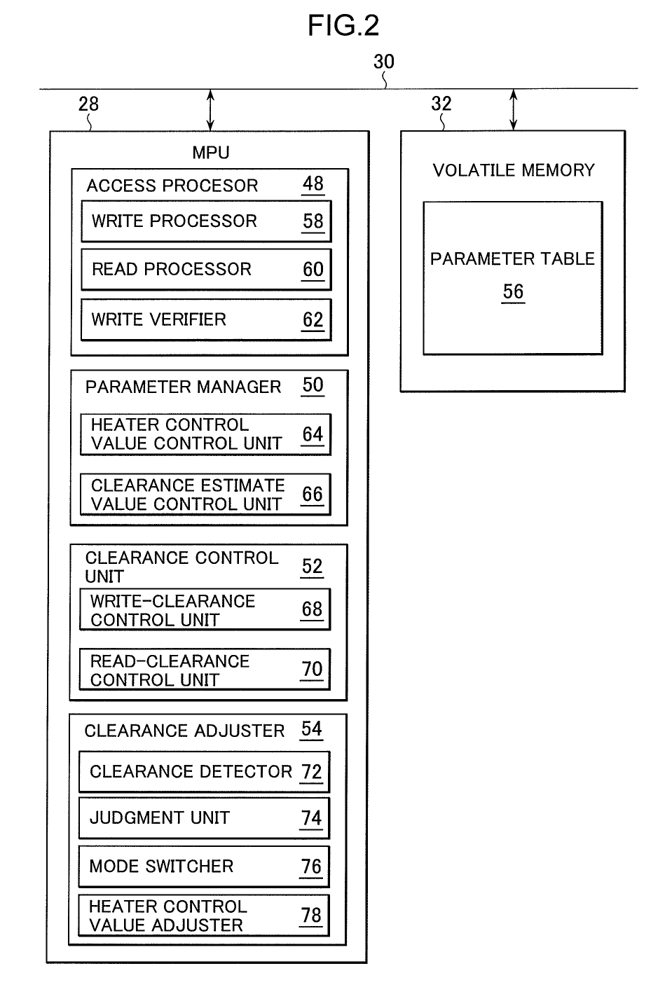

FIG. 2 is the block diagram showing the functional structure of MPU 28 shown in FIG. 1 in detail. Access processor 48 included in MPU 28 functions such as write processor 58, read processor 60 and write verifier 62.

Write processor 58 writes the write data in a target sector of a target track on a magnetic disk specified by a decoded write command on receiving the write command issued by the host. Read processor 60 reads out data from a target sector of a target track on a magnetic disk specified by a decoded read command to the host on receiving the read command issued by the host.

Write verifier 62 checks for error by reading data written on the magnetic disk immediately after writing. In this embodiment, write verifier 62 is selected and operated in switching write modes in a clearance adjustment operation. The clearance adjustment operation will be discussed later.

Parameter manager 50 has heater control value control unit 64 and clearance estimate value control unit 66. Heater control value control unit 64 registers heater control values for setting the clearance from the head to a prescribed target value in parameter table 56 at the fabrication stage, and manages the values. In writing or reading, an appropriate heater control value is read out from parameter table 56 and set to clearance control unit 52.

Clearance estimate value control unit 66 registers clearance estimate values detected with the head heated according to the heater control value managed by heater control value control unit 64 in parameter table 56 at the fabrication stage, and manages the value. Clearance estimate value control unit 66 reads out the appropriate clearance estimate value registered from parameter table 56 as a reference value for clearance adjustor 54 for judging the clearance decrease.

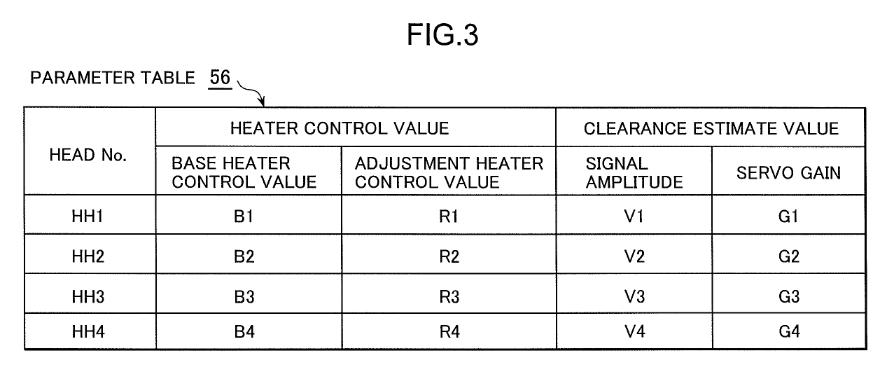

FIG. 3 is parameter table 56 providing the values registered and managed by heater control value control unit 64 and clearance estimate value control unit 66.

Parameter table 56 in FIG. 3 has the heater control values and the clearance estimate values for each head, No. HH1, HH2, HH3 and HH4. In this embodiment, the heater control values are classed into two categories: base heater control values (in other words, the first heater control values) and adjustment heater control values (in other words, the second heater control values).

The base heater control values are data input to the DA converters for setting current applied to the heater embedded in the head in writing or reading. The adjustment heater control values are data input to the DA converters to be added to the base heater control value for setting the current applied to the heater in preheating except for writing or in reading.

In this embodiment, the four heads HH1 to HH4 are provided. Thus, the base heater control values B1 to B4 and the adjustment heater control values R1 to R4 are registered as the heater control values.

Further, in parameter table 56, signal amplitudes V1 to V4 and servo gains G1 to G4 are registered as the clearance estimate values. The signal amplitudes and the servo gains consisting of the clearance estimate values are detected at the fabrication stage by the same function of clearance detector 72 included in clearance adjustor 54 shown in FIG. 2. Clearance detector 72 detects and registers amplitude of the signal read out from a preamble in a servo region of a magnetic disk read out with the head and a servo gain G that amplifies the signal as the clearance estimate values at the fabrication stage.

In FIG. 3, parameter table 56 provides both the signal amplitudes and the servo gains as the clearance estimate values. However, an actual apparatus may not need either of them.

As shown in FIG. 2, clearance control unit 52 of MPU 28 has write-clearance control unit 68 and read-clearance control unit 70. Write-clearance control unit 68 controls the clearance in writing to a target value by preheating the head from the specified number of the sectors before a target sector. For instance, where head No. HH1 shown in parameter table 56 is selected, the head is preheated by the heater according to the control value given by adding base heater value B1 and adjustment heater value R1 (B1+R1). After reaching the target sector, the head is heated according to base heater control value B1 only to control the clearance to the target value in writing.

Read-clearance control unit 70 preheats the head by applying the current to the heater according to the control value give by adding base heater control value B1 to adjustment heater control value R1 (B1+R1) from the specified number of the sectors before the target sector in reading. After the head reaches the target sector, read-clearance control unit 70 maintains the control value to meet the clearance with a target value.

Clearance adjustor 54 of MPU 28 shown in FIG. 2 has clearance detector 72 and judgment unit 74, mode switcher 76 and heater control value adjustor 78. Where a clearance decrease due to an atmospheric pressure that is lower than the ordinary atmospheric pressure at the fabrication stage is detected on turning on magnetic disk device 10, clearance adjustor 54 switches from a regular write mode to a write verification mode. Then the clearance is increased by decreasing the heater control value by degrees until the error is corrected in executing the write verification.

More precisely, clearance detector 72 detects the clearance estimate value with the head heated according to the heater control value registered in parameter table 56 shown in FIG. 3 by read-clearance control unit 70 on turning on the power magnetic disk device 10 by a user after a factory shipment.

Likewise detecting the clearance estimate value registered in parameter table 56 at the fabrication stage, clearance detector 72 detects either of the amplitude of the signal read out with the head or the servo gain included in servo information as the clearance estimate value.

At the fabrication stage, where the signal amplitude is used as the clearance estimate value, clearance detector 72 detects the signal amplitude on turning on the power as the clearance estimate value. Where the servo gain is used as the clearance estimate value at the fabrication stage, clearance detector 72 detects the servo gain as the clearance estimate value on turning the power on.

Judgment unit 74 detects the clearance decrease by comparing the clearance estimate value detected by clearance detector 72 on turning on the power, i.e., the amplitude of the servo signal or the servo gain, with the clearance estimate value registered in the parameter table 56 at the fabrication stage, i.e., the amplitude of the servo signal or the servo gain.

Where using the signal amplitude as the clearance estimate value, the clearance is assumed to have decreased when the signal amplitude detected on turning on the power increases compared to the registered signal amplitude. Where using the servo gain as the clearance estimate value, the clearance is assumed to have decreased when the servo gain detected on turning on the power decreases compared to the registered servo gain.

Mode switcher 76 switches from the regular write mode in which the data is recorded on a magnetic disk, that is, a write mode operated by write processor 58, to the write verification mode in which the data written on the magnetic disk is read immediately after writing for checking possible error, that is, an operation mode operated by write verifier 62.

Heater control value adjustor 78 executes processes in the write verification mode switched by mode switcher 76 and operated by write verifier 62. When an error is detected, heater control value adjustor 78 adjusts the heater control value by repeatedly executing the write verifications and reducing the heater control value registered in parameter table 56 by specific values until the error is corrected.

The heater control value adjustor adjusts the heater control value by about 0.5-1 nm at one time.

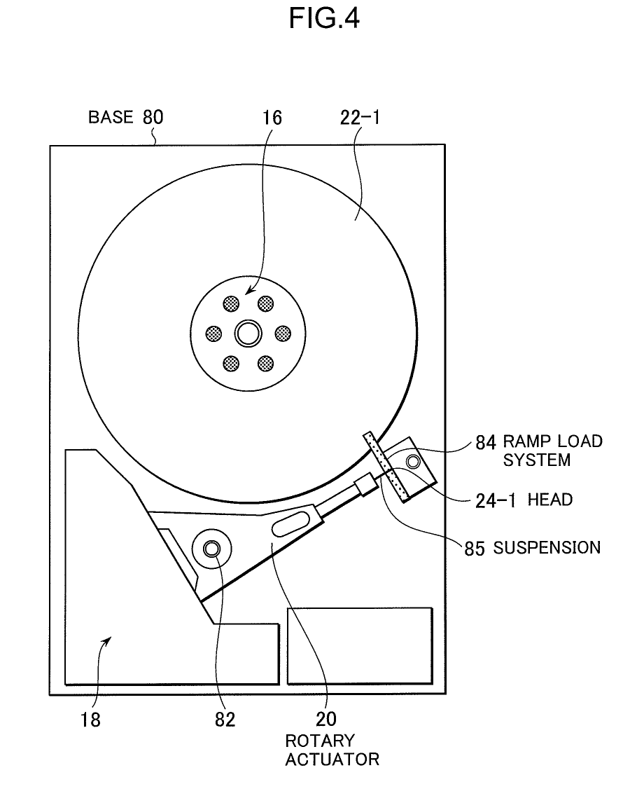

FIG. 4 shows the inner structure of the magnetic disk device according to this embodiment. In FIG. 4, the magnetic disk device has mounted therein magnetic disks 22-1 and 22-2 that are rotated at constant speed by a spindle motor mounted on base 80.

Rotary actuator 20 is rotatable about axis 82, laid out alongside the magnetic disks 22-1 and 22-2. Suspensions 85 are provided on arms of rotary actuator 20. On a tip of one of the suspensions 85, head 24-1 is provided. On the other end of rotary actuator 20, a coil is provided. The coil is rotatable between yokes laid out on and under the coil. Voice coil motor 18 consists of the coil and the yokes fixed on base 80. When the power is turned off, head 24-1 is retracted and locked in ramp road system 84.

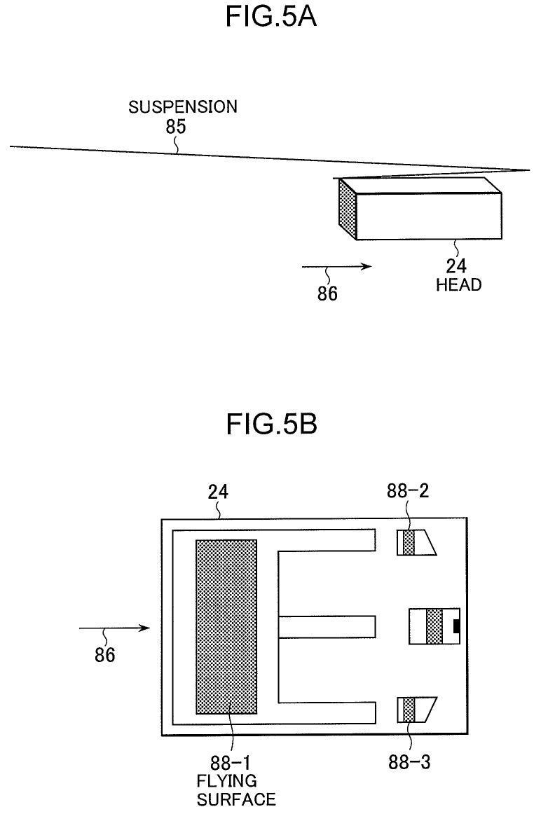

FIG. 5A shows the support structure of the head according to this embodiment. In FIG. 5A, suspension 85 attached to the tip of the rotary actuator and head 24 are shown. Suspension 84 is a spring member made of a thin metal sheet, having head 24 on its tip. Suspension 84 functions to plane head 24 over the magnetic disk by utilizing airflow produced by disk rotation direction 86 in rotating the disk.

FIG. 5B shows the head structure for flying according to this embodiment. In FIG. 5B, a plan view head 24 viewed from the surface opposed to the medium is shown. Flying surfaces 88-1, 88-2 and 88-3 are formed on the opposed surface. The head 24 flies with the airflow flowing in the disk rotation direction 86 in the flying surfaces 88-1, 88-2 and 88-3.

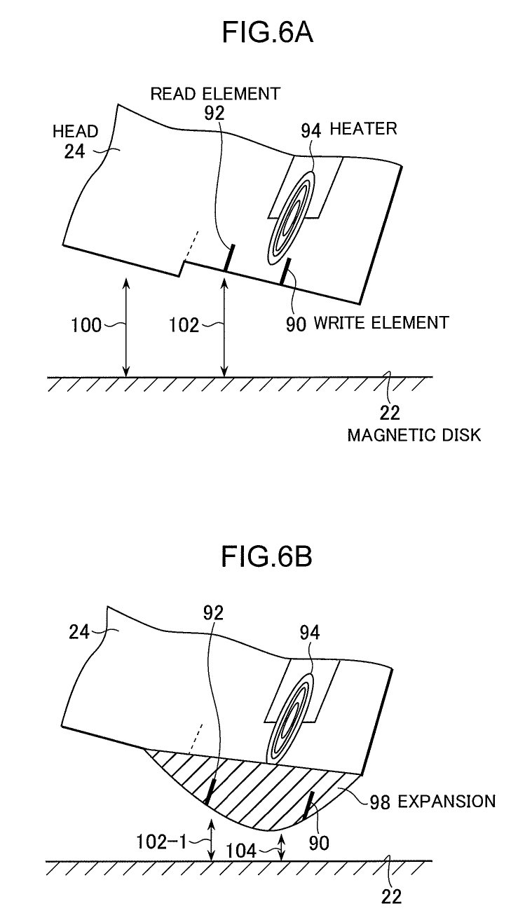

FIG. 6A shows the head on the fly, without current applied to the heater. Head 24 shown in FIG. 6A has write element 90 and read element 92 near the opposed surface to the magnetic disk 22 in that order from the edge of the head. Heater 94 is embedded in the head in the vicinity of write element 90.

FIG. 6A shows head 24 flying with the airflow produced in rotating magnetic disk 22 at the constant speed. Usually, the clearance between head 24 and magnetic disk 22, i.e., clearance 100, is measured by an optical measurement. At the fabrication stage, the optical measurement is feasible. However, as described with this embodiment, after shipping the magnetic disk device, it is impossible to measure the clearance 100 by the optical measurement on turning on the power by a user.

In this embodiment, clearance 102 is measured based on a signal read out with the read element 92 of head 24. This can be implemented by a correlation between a read-out from magnetic disk 22 with read element 92 and clearance 102. That is to say, the more the clearance increases, the more the read-out decreases. The more the clearance decreases, the more the read-out increases.

FIG. 6B shows the clearance from the head controlled by the current applied to the heater. In this embodiment, the clearance is controlled on the order of several nanometers of a target value by expanding the head into expansion space 98 with electric heat generated by heater 94 embedded in head 24.

Head 24 is drawn near magnetic disk 22 by applying the current to the heater 94 concurrently with applying the current for writing to write element 90.

In this embodiment, clearance 102-1 is derived from the read-out read with read element 92 on turning on the power. However, only clearance estimate value 102-1, a possible contact with the disk is unable to be avoided correctly, because contact with the recording surface of magnetic disk 22 cannot be detected correctly without actually deriving clearance 104.

In this embodiment, the clearance decrease is detected by comparing the clearance estimate value derived from clearance 102-1 read with read element 92 on turning on the power with the clearance estimate value derived at the fabrication stage. Where a clearance decrease is detected, the regular write mode is switched to the write verification mode.

In the write verification mode, current is applied to heater 94 concurrently with applying the write-current to write element 90, thereby producing expansion 98. Thus, the clearance becomes narrowest as shown in FIG. 6B. With the head expanded, data is read immediately after writing in the write verification mode. Where errors are detected, the write verifier judges potential head contact with the surface of magnetic disk 22, repeating the write verifications by decreasing the current applied to heater 94 by a certain amount.

By adjusting the heater control value for heater 94 until the error is corrected, the contact with the head in use in a lower atmospheric pressure compared to the ordinary atmospheric pressure at the fabrication stage can be avoided. Therefore, writing and reading user data are executed correctly, and errors in reading are avoided.

The reason why the error occurs when the head contacts the medium in the write verification mode is that when the head contacts with the disk, the head bounces repeatedly and therefore the clearance changes widely. As the clearance becomes wider, a magnetic field radiated from the written data becomes weaker, resulting in reading errors.

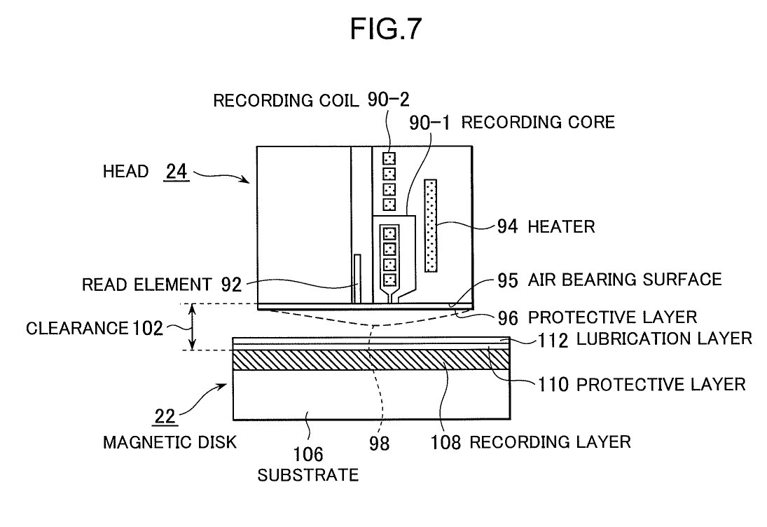

FIG. 7 shows the head structure according to this embodiment in detail. Head 24 shown in FIG. 7 has recording core 90-1 and recording coil 90-2 as a write element in an insulation portion made of ceramic. Read element 92 is laid out on the left side of this write element. On the surface of head 24 opposed to magnetic disk 22, air bearing surface (ABS) 95 having protective layer 96 thereon is provided.

Magnetic disk 22 has substrate 106, recording layer 108, protective layer 110 and lubricant 112 in that order. Additionally, heater 94 is provided in the vicinity of recording core 90-1 included in the write element of head 24.

When head 24 is heated by applying the current to heater 94, the flying surface of head 24, in other words, the ABS surface of head 24 is expanded by heat towards magnetic disk 22, conforming generally to expansion space 98. Clearance 102 between head 24 and magnetic disk 22 is defined as a distance from the bottom edge of read element 92 to protective layer 110 of magnetic disk 22.

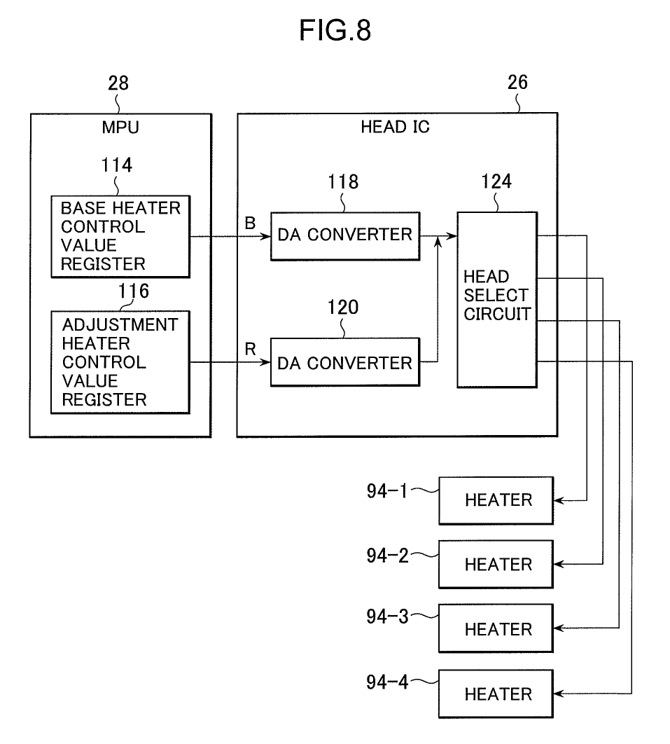

FIG. 8 is a block diagram showing the heater control system according to this embodiment. As shown in FIG. 8, MPU 28 has base heater control value register 114 and adjustment heater control value register 116. In writing or reading, the base heater control value B and the adjustment heater control value R corresponding to a specified head are read out from parameter table 56 shown in FIG. 3; and set to base heater control value register 114 and adjustment heater control value register 116.

Head IC 26 has DA converters 118 and 120. The DA converters convert the heater control values B and R configured in base heater control value register 114 and adjustment heater control value register 116 from digital to analog signals, and then sums them up. Thereafter, current is applied to any of heaters 94-1 to 94-4 that correspond to the selected head via head select circuit unit 124 to expand the selected head with heat. Thus, the clearance between the head and the medium is controlled, and is set with a preset clearance value.

In preheating or reading, the heater control values B and R are set by base heater control value register 114 and adjustment heater control value register 116. Therefore, the heater control value in preheating or reading is B+R.

In writing, only the heater control value B is set to the value stored in the base heater control value register 114. The heater control value R for adjustment by heater control value register 116 is zero in writing. Thus the heater is controlled with the base heater control value B alone. In a strict sense, in addition to the base heater control value B, the heat associated with the current for writing also contributes to the thermal expansion of the head.

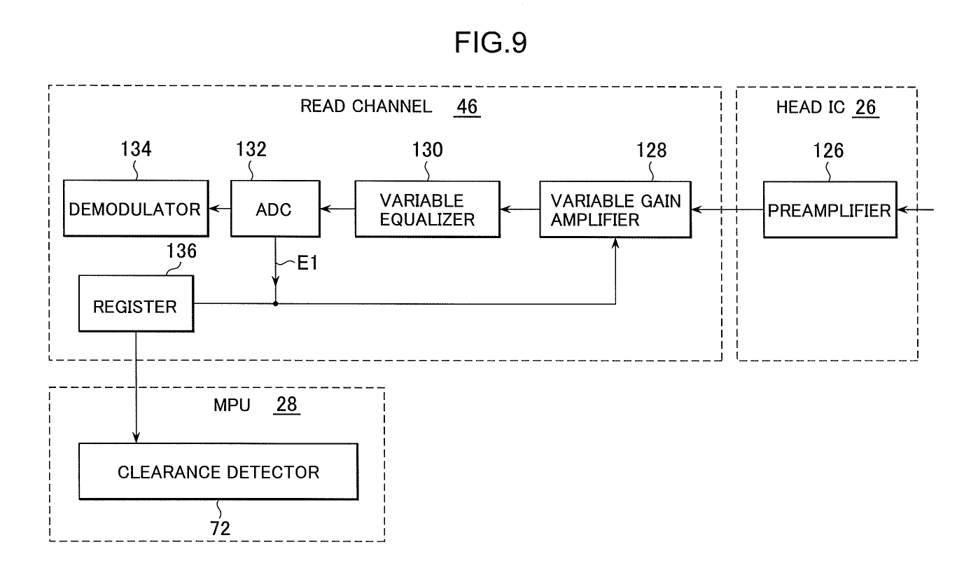

FIG. 9 is a block diagram showing the circuit unit for detecting the read-out signal amplitude to derive the clearance estimate value in accordance with this embodiment. FIG. 9 shows read channel 46 and head IC 26 included in magnetic disk device 10. Head IC 26 has preamplifier 126. The signal tapped from preamplifier 126 is amplified by variable gain amplifier (VGA) 128 included in read channel 46, equalized by variable equalizer 130, sampled by AD converter 132, converted to digital data, and demodulated by demodulator 134 in that order to produce the data and the servo information.

Automatic gain control (AGC) signal E1, in other words, a servo gain signal, is supplied from AD converter 132 to maintain the signal amplitude output from variable amplifier 128. In this embodiment, register 136 stores the AGC signal E1 that is sent to variable gain amplifier 128. Clearance detector 72 of MPU 28 derives and obtains the amplitude of the signal read out with the head based on the AGC signal E1 stored in register 136.

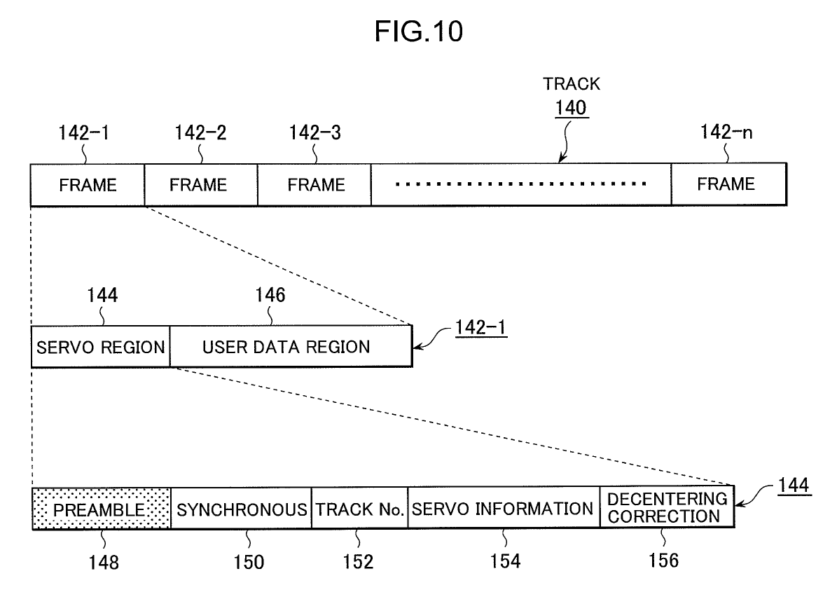

FIG. 10 shows the structure of the track from which signal amplitude is detected to produce the clearance estimation in FIG. 9. As shown in FIG. 10, track 140 has n frames 142-1 to 142-n. For convenience, the frame is illustrated linearly. Frame 142-1 includes servo region 144 and user data region 146 as shown in the middle of FIG. 10.

Further, servo region 144 includes preamble region 148, synchronous region 150, track number region 152, servo information region 154 and decentering correction region 156 as shown at the bottom of FIG. 10. In preamble region 148, a repeated pattern with a prescribed frequency that is lower than a record basic frequency of user data is stored as a preamble pattern. The amplitude of the preamble pattern is obtained by reading the preamble pattern.

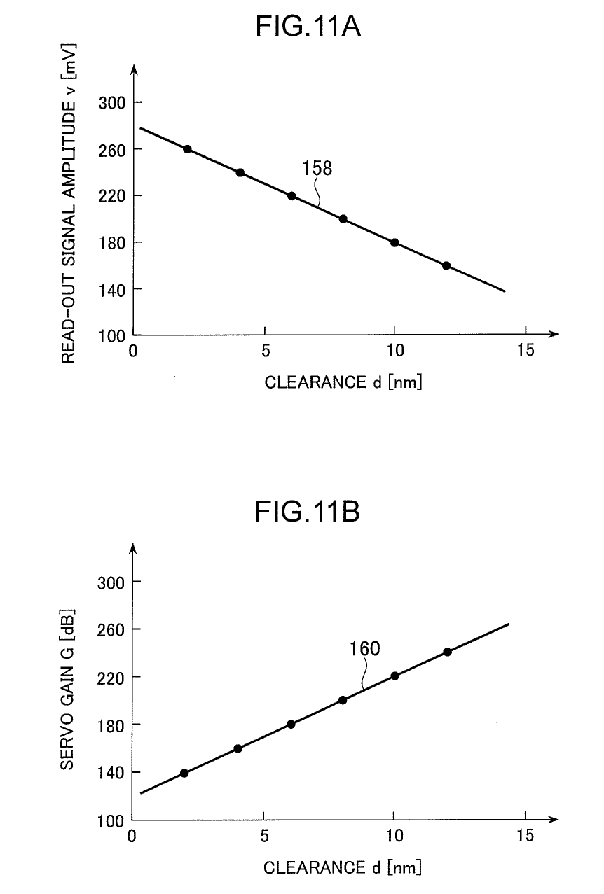

FIG. 11A shows the relationship between a signal amplitude V read out and obtained by the circuit unit shown in FIG. 9 and a clearance d. In FIG. 11A, the clearance d ranges from 0 to 15 nm. As the read-out signal amplitude V increases, the clearance d decreases. That is to say, as the signal amplitude decreases, the clearance d increases substantially linearly.

According to the embodiment shown in FIG. 9, the signal amplitude is derived from the AGC signal E1 stored in register 136. Alternatively, the AGC signal E1, namely the servo gain stored in register 136, may be used as the clearance estimate value.

FIG. 11B shows the relationship between the clearance d and a servo gain G, namely the AGC signal. As the clearance d decreases, the servo gain G increases. As the clearance d increases, the signal amplitude decreases, thus, the servo gain G increases.

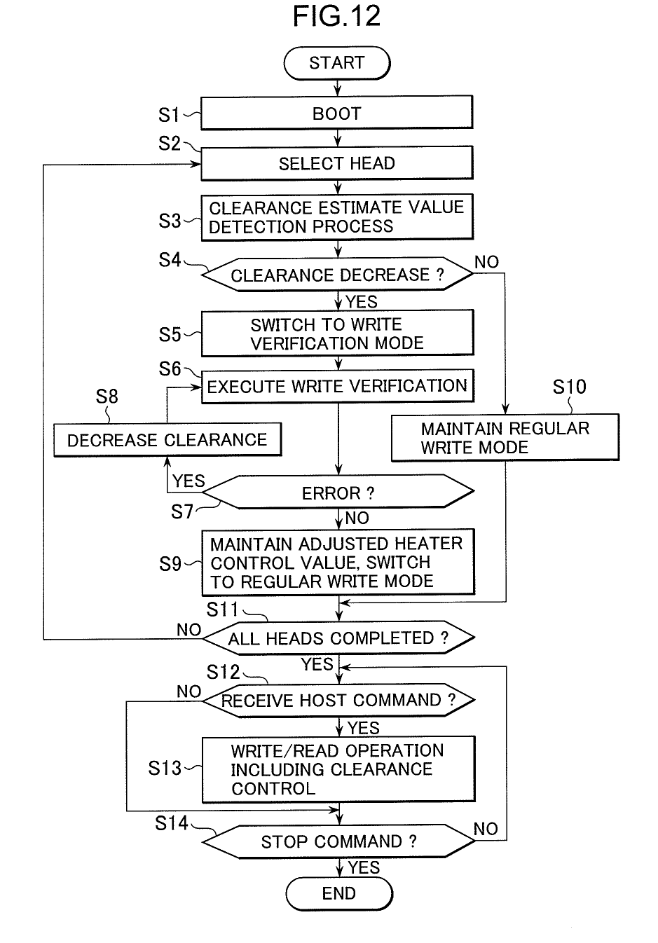

FIG. 12 shows the control processes including the clearance adjustment in the write verification executed by the magnetic disk device according to this embodiment. As shown in FIG. 12, when booting magnetic disk device 10 with the factory-shipped configuration, a boot process is executed in step S1.

During the boot process, an initialization diagnostic process is executed with a boot code stored in nonvolatile memory 34; and the firmware and parameter table 56 stored in nonvolatile memory 34 and a system region of the magnetic disk are loaded to volatile memory 32 concurrently with actuating spindle motor 16 to rotate magnetic disks 22-1 and 22-2 at the constant speed. Therefore, the disks become accessible.

In step S2, clearance adjustor 54 included in MPU 28 executes the following process. First, clearance adjustor 54 selects a head, i.e., the head No. HH1.

In step S3, a clearance estimate value determination process is executed. The clearance estimate value is determined as follows: 1) Obtain the base heater control value B1 and the adjustment heater control value R1 corresponding to the selected head No. HH1 from parameter table 56 as the heater control value. 2) Set the heater control values Bland R1 from base heater control value register 114 and adjustment heater control value register 116 of MPU 28 shown in FIG. 8. 3) Convert the digital signal to an analog signal by DA converters 118 and 120. 4) Apply the current according to the heater control value B1+R1 to heater 94-1 embedded in the selected head HH1 via head select circuit 124. Thus, the preamble signal amplitude read out from the servo region by the circuit unit shown in FIG. 9 is detected as the clearance estimate value with the heater control value registered in parameter table at the fabrication stage.

In step S4, the clearance estimate value detected in step S3 is compared with the signal amplitude V1, in other words, the clearance estimate value registered at the fabrication stage in parameter table 56. Where the detected signal amplitude decreases, the clearance is assumed to decrease, and the process moves on to step S5, where the regular write mode is switched to the write verification mode.

After entering the write verification mode, write verification is executed in step S6. The write verification is executed by write verifier 62 included in access processor 48 shown in FIG. 2. For instance, test data is read immediately after writing on a certain track in the system region on the recording surface of magnetic disk 22-1 with head 24-1 corresponding to the selected head No. HH1 for checking errors in data reading.

If an error is detected in step S7 after executing the write verification in step S6, the process moves on to step S8. In step 58, the clearance is increased by a certain amount. More precisely, the currently configured base heater control value B1 provided by the parameter table 56 is corrected to a heater control value (B1−ΔB) that is given by subtracting a heater control value change ΔB corresponding to a preset clearance change amount Δd. Then the process returns to step S6, and the write verification is executed using the changed heater control value (B1−ΔB) and the adjustment heater control value R1.

Steps S6 through S8 are repeated in step S7 until the error is corrected, by increasing the clearance by a certain amount in executing the write verifications. Thereafter, the changed heater control value is stored over the default base heater control value B1 from parameter table 56 in volatile memory 32. Then the write verification mode is switched to the regular write mode.

Where the clearance decrease is not detected in step S4, the process moves to step S10 with the regular write mode maintained. In step S11, the heads are checked to determine whether all have been processed. If not, the process returns to step S2. An unprocessed head is selected, and processed in the manner described above.

Where the completion of the processes of all heads is confirmed in step S11, the adjustment of the heater control value for contact prevention even in the low atmospheric pressure is completed. In step S12, the mode is switched to a regular idling mode in which the magnetic disk device is standing by for a command issued by the host.

After receiving the write command or the read command issued by the host, the process moves to step S13. The write process or the read process including the clearance control is executed until a stop command is issued in step S14.

Receiving the stop command in step S14, the power of the magnetic disk device is turned off, and the changed heater control value stored in parameter table 56 in volatile memory 32 is lost. In the next booting, an optimal clearance for the atmospheric pressure in use is determined by executing the processes including the write verification from step S1 shown in FIG. 12.

If needed, the heater control value as adjusted when turning on the power is stored in nonvolatile memory 34 as a reference heater control value for determining operation of the clearance estimate value on the next booting. In this manner, adjusting the heater control value can be omitted or curtailed when the magnetic disk device is used in the same low atmospheric pressure.

With this technique, the clearance decrease is detected by comparing the heater control value configured in ordinary atmospheric pressure at the fabrication stage with the clearance estimate value derived from the servo signal amplitude read out with the head in the user-initiated environment. The decrease of the clearance is adjusted by write verification. In the write verification, the heater control value is decreased by a certain amount until the error is corrected. Thus, contact with the medium in low atmospheric pressure in writing or reading can be avoided, enhancing reliability of user data writing and reading.

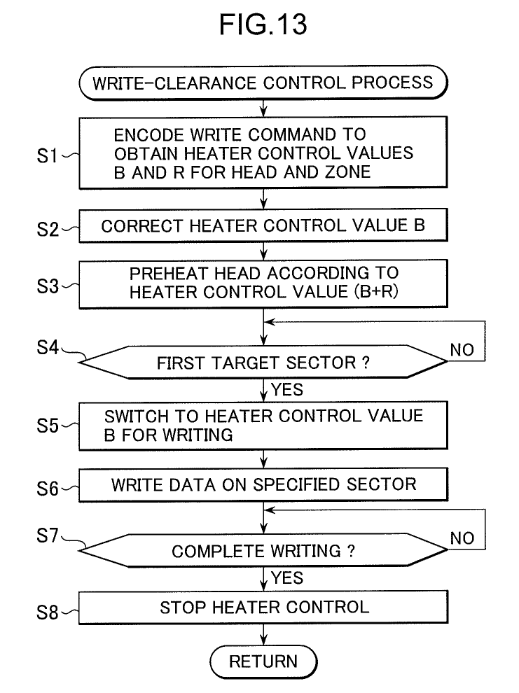

FIG. 13 is a flow chart showing the write-clearance control process according to this embodiment, processed by write-clearance control unit 68 shown in FIG. 2. In the write-clearance control process, a write command is encoded and a target track is recognized in step S1. Then the base heater control value B and the adjustment heater control value R corresponding to a head and a zone specified are obtained with reference to parameter table 56.

In step S2, the obtained base heater control value B is corrected to adapt to a temperature. In the parameter table 56, the heater control values at an ordinary temperature of 30 degrees centigrade in the device are registered. Where a current temperature T in the device is defined as T, a differential ΔT between the prescribed temperature and the current temperature is given by ΔT=T−30 degrees centigrade. A temperature correction value Bt is determined by multiplying the differential ΔT by a conversion coefficient of the heater control value per unit temperature. Then B is corrected by B=B+Bt.

Where the temperature in the device is higher than 30 degrees centigrade the temperature correction value Bt becomes negative. Thus the temperature correction value Bt is subtracted from the base heater control value B. Where the temperature in the device is lower than 30 degrees centigrade the temperature correction value Bt becomes positive, and the temperature correction value Bt is added to the base heater control value B.

In step S3, the head is preheated in accordance with the heat control value B+R from the specified number of the sectors before the target sector. When the head reaches the first target sector in step S4, then the head has already been heated according to the heater control value B for writing in step S5. In step S6, data is written on the target sector. When the write operation is completed in step S7, the heater control is turned off in step S8.

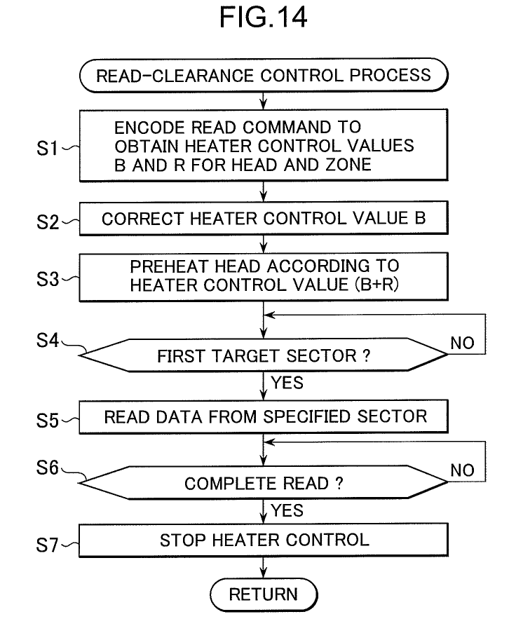

FIG. 14 is a flow chart showing the read-clearance control process according to this embodiment, executed by read-clearance control unit 70 shown in FIG. 2. In the read-clearance control process, the read command is encoded to recognize a target track in step S1. Then the base heater control value B and the adjustment heater control value R corresponding to a head and a zone specified are obtained with reference to parameter table 56 shown in FIG. 3.

In step S2, the obtained base heater control value B is corrected to adapt to the temperature. In the parameter table 56, the heater control values at an ordinary temperature of 30 degree centigrade in the device are registered. Where a current temperature T in the device is defined as T, a differential ΔT between the prescribed temperature and the current temperature is given by ΔT=T−30 degrees centigrade. A temperature correction value Bt is determined by multiplying the differential ΔT by a conversion coefficient of the heater control value per unit temperature. Then B is corrected by B=B+Bt.

In step S3, the head is preheated in accordance with the heat control value B+R before reaching a target sector. When the head reaches the first target sector in step S4, the process moves to step S5 and starts a reading operation with the heater control value B+R maintained. When the read operation is completed in step S6, the heater control can be turned off in step S7.

The clearance control in the write verification process by write verifier 62 shown in FIG. 2 is executed by a combination of the write-clearance control shown in FIG. 13 and the read-clearance control shown in FIG. 14. More precisely, the steps from S1 to S8 of the write-clearance control are executed before executing the steps from S3 to S7 of the read-clearance control.

This technique aims to provide a firmware as a control program executed by MPU 28 of magnetic disk device 10. The firmware executes the processes shown in FIGS. 12 to 14.

The embodiment described above is an example using the base heater control value and the adjustment heater control value as the heater control value for the clearance control. However, the clearance control may use either of the heater control value that supports the clearance control in preheating, writing or reading.

In the embodiment described above, this technique is applicable particularly, but not limited, to a magnetic disk device. This technique also applicable to the clearance control of ahead slider having an optical head element, a magneto-optical head, or a magnetic field applied head for an optical recording device such as an optical disk device or a magneto-optical disk device.

This technique includes variations that do not impair its object and advantage. This technique is not considered to be limited to figures cited according to the embodiment described above.

The turn of the embodiments isn't a showing the superiority of the invention. Although the embodiments of the present inventions has been described in detail, it should be understood that the various changes, substitutions, and alterations could be made hereto without departing from the spirit and scope of the invention.

What is claimed is:

1. A storage apparatus for flying a head having an electric heater for changing a clearance between the head and a rotating recording medium by expanding the head with heat when accessing data written on said recording medium, the storage apparatus comprising:
a judgment unit which judges the clearance between said head and said recording medium;
a mode switcher which switches from a regular write mode in which data is written on said recording medium to a write verification mode in which error is checked by reading the data immediately after writing on said recording medium, so that said judgment unit can detect a clearance change;
a heater control value adjustor which corrects error detected in said write verification mode to which said mode switcher switches by changing a heater control value for said heater by executing write verifications; and
an access processor which controls the clearance between said head and said medium by heating the head according to said adjusted heater control value.

2. A storage apparatus for flying a head when a recording medium is rotating, accessing data written on the medium with the head, the head having an electric heater for changing a clearance between an element and the medium by expanding the head with heat, the storage apparatus comprising:
a heater control value control unit which registers a heater control value which sets the clearance to a prescribed target value at a fabrication stage of the apparatus, and controlling the heater control value;
an clearance estimate value control unit which registers a clearance estimate value detected with the head heated by the heater according to said heater control value at the fabrication stage, and controlling the clearance estimate value;
a clearance detector which detects the actual clearance estimate value with the head heated according to said registered heater control value on turning on power to the head;
a judgment unit which judges a clearance decrease by comparing said clearance estimate value detected on turning on the power with said registered clearance estimate value;
a mode switcher which switches from a regular write mode in which data is written on said recording medium to a write verification mode in which error is checked by reading the data immediately after writing on said recording medium where said judgment unit detects the clearance decrease;
a heater control value adjustor which adjusts a heater control value by decreasing said registered heater control value by a prescribed value to increase the clearance in said write verification mode until an error detected in the write verification mode that is selected by said mode switcher is corrected; and
an access processor which accesses data written on said recording medium by controlling the clearance between said head and the medium by heating the head according to said heater control value on receiving an access request from a higher level device.

3. The storage apparatus according to claim 2, wherein said heater control value control unit registers and controls said heater control value determined at the fabrication stage in ordinary atmospheric pressure and controls the heater control value, and said clearance estimate value control unit registers said clearance estimate value detected at the fabrication stage in the ordinary atmospheric pressure.

4. The storage apparatus according to claim 2, wherein said clearance detector detects a signal amplitude of servo information written on said recording medium read out with the head as the clearance estimate value, and said judgment unit judges that a clearance decreases where the detected signal amplitudes increases compared to the registered signal amplitude.

5. The storage apparatus according to claim 2, wherein said clearance detector detects a servo gain for amplifying the signal of the servo information written on said recording medium and read out with the head as said clearance estimate value, and said judgment unit judges that the clearance decreases where the detected servo gain is lower than the registered servo gain.

6. The storage apparatus according to claim 2, wherein said mode switcher maintains said regular write mode where said judgment unit does not detect the clearance decrease.

7. The storage apparatus according to claim 2, wherein said heater control value adjustor switches from said write verification mode selected by said mode switcher to the regular write mode where no error is detected in said write verification, or where the error has been corrected by adjusting the heater control value in said write verification.

8. The storage apparatus according to claim 2, wherein said heater control value control unit registers and uses a first heater control value for setting current applied to said heater in preheating, writing and reading and a second heater control value to be added to said first heater control value in setting current applied to the heater in preheating except for writing and in reading, and said heater control value adjustor increasing the clearance by decreasing said first heater control value by the specific value.

9. The storage apparatus according to claim 8, wherein said access processor comprises a write-clearance control unit which preheats the head with electricity applied to said heater according to a control value given by adding said first heater control value to said second heater control value from the specified number of sectors before a target sector and heating the head based only on said first heater control value after reaching the target sector in writing, and said access processor further comprises a read-clearance control unit which preheats the head by said heater applied current according to a control value given by adding said first heater control value to said second heater control value from the specific number of the sectors before a target sector, and maintains the control value after reaching the target sector in reading.

10. A control method for storage apparatus for flying the head over the rotating medium and accessing data written on said recording medium by said head having a heater for changing a clearance by expanding the head with electric heat, the storage apparatus comprising:
judging a clearance change between said head and said recording medium;
switching from a regular write mode in which data is written on said recording medium to a write verification mode in which error is checked by reading the data written on said recording medium immediately after writing;
adjusting a heater control value for said heater by changing a prescribed heater control value when an error is detected in said write verification mode until the error is corrected; and
accessing data written on said recording medium by controlling the clearance between the said head and the medium by heating the head according to said heater control value as adjusted, on receiving an access request from a higher level device.

11. A control method for a storage apparatus for accessing data by flying a head element having a heater for changing the clearance between the head and a rotating recording medium by heating the head, the head element expanding with the electric heat over the rotating recording medium, the control method comprising:
registering a heater control value for setting the clearance between said head and the medium to a prescribed target value at the fabrication stage determining a clearance estimate value;
registering the clearance estimate value for said head detected with the head heated to said heater control value;
detecting the clearance estimate value for said head with the head heated with electric heat generated by the heater according to said heater control value registered on turning on power to the storage apparatus;
judging a clearance decrease compared with said clearance estimate value detected on turning on the power with said registered clearance estimate value;
switching from a regular write mode in which data is written on said recording medium to a write verification mode and checking for by reading the data immediately after writing on said recording medium when the clearance decrease is detected in said judging operation;
adjusting the heater control value by decreasing said registered heater control value by a specific value to increase the clearance in executing a write verification process until the error detected in said write verification selected by said mode switcher is corrected; and
accessing the data written on said recording medium by controlling the clearance between said head and the medium by heating the head to said heater control value on receiving an access request from a higher level device.

12. The control method according to claim 11, wherein said heater control value controlling operation registers said heater control value determined at the fabrication stage in ordinary atmospheric pressure, and said clearance estimate control value controlling operation registers said clearance estimate value detected at the fabrication stage in ordinary atmospheric pressure.

13. The control method according to claim 11, wherein said clearance detecting operation detects the signal amplitude of servo information written on said recording medium read out with the head as said clearance estimate value, and said judging operation judges a decrease of the clearance where the detected signal amplitude increases compared with the registered signal amplitude.

14. The control method according to claim 11, said clearance detecting operation detects a servo gain for amplifying the read-out signal of the servo information written on said recording medium as said clearance estimate value, and said judging operation judges a clearance decrease where the detected servo gain is lower than the registered servo gain.

15. The control method according to claim 11, wherein said mode switching operation maintains said regular write mode where the clearance decrease is not detected in said judging operation.

16. The control method according to claim 11, wherein said heater control value adjusting operation switches from said write verification mode to the regular write mode where no error is detected in said write verification mode selected in said mode switching operation, or where the error is corrected by adjusting the heater control value in said write verification mode.

17. The control method according to claim 11, wherein said heater control value controlling operation registers and controls a first heater control value for setting the current applied to said heater in preheating, writing and reading and a second heater control value that is added to the first heater control value for setting the current applied to the heater in preheating except for writing and reading, and controls the first and second heater control values, and said heater control value adjusting operation increases the clearance by decreasing said first heater control value by a specific value.

18. The control method according to claim 17, wherein said accessing operation comprises a write-clearance control operation for preheating the head with current applied to said heater according the control value given by adding said first heater control value to said second heater control value from a prescribed number of sectors before reaching a target sector and for heating the head according to said first heater control value only in writing when the head reaches the target sector, and the read-clearance control operation for preheating the head with the current applied to said heater according to the control value given by adding said first heater control value to said second heater control value from the prescribed number of the sectors before reaching the target sector and for maintaining said control value after reaching the target sector in reading.
